(19) United States
(12) Patent Application Publication
(10) Pub. No.: US 2002/0194378 A1
(43) Pub. Date: Dec. 19, 2002

(54) System and method of hiding an internet protocol (IP) address of an IP terminal during a multimedia session

(76) Inventor: George Foti, Dollard des Ormeaux (CA)

Correspondence Address: ERICSSON RESEARCH CANADA, 8400 DECARIE BLVD., MONTREAL, QC, H4P 2N2, CA

(21) Appl. No.: 09/826,601

(22) Filed: Apr. 5, 2001

(51) Int. Cl. G06F 15/16

(52) U.S. Cl. 709/246

(57) ABSTRACT

A system and method of hiding the source Internet Protocol (IP) address of an originating and/or terminating terminal during media flow by routing IP packets through an enhanced Media Resource Function (MRF) that removes the source address and substitutes an alias address. The MRF performs an address translation by mapping the source address to an IP address for the MRF and then forwarding the packets to the terminating terminal. The terminating terminal sees the MRF address as the source address for the packets. Packets returned in the opposite direction are addressed to the alias address at the MRF. The MRF then substitutes the originating terminal's IP address for the destination address, and forwards the packets to the originating terminal.

### BACKGROUND OF THE INVENTION

1. Technical Field of the Invention

The invention relates to telecommunication systems and, more particularly, to a system and method of hiding an Internet Protocol (IP) address of an IP terminal during a multimedia session.

2. Description of Related Art

Wireless telecommunication networks are evolving from second generation (2G) circuit switched networks to third generation (3G) packet-switched networks. A reference architecture for a 3G wireless network is being developed by the Third Generation Partnership Project (3GPP). An IP network takes bits of digitized media, packetizes them, puts on a header, and ships them over the network. The header includes, among other things, the source and destination addresses of the packets. The packetized media may enter the core IP network at any access (edge) router near the originating subscriber. Thereafter, the individual packets follow any available route to the destination address. At that point, all of the packets exit the core network through a single access router near the destination subscriber.

3GPP networks currently do not support a way to allow IP addresses used for exchanging media to be hidden between end users. Because IP addresses can reveal location information and possibly identity, some subscribers would like to hide their IP addresses. In order to overcome the existing shortcomings of the related and existing art it would be advantageous to have a method within 3GPP networks of hiding IP addresses upon request by end user(s). The present invention provides such a system and method.

### SUMMARY OF THE INVENTION

In one aspect, the present invention is a method of hiding an Internet Protocol (IP) address of an originating IP terminal from a terminating IP terminal, and/or vice versa, during a multimedia session in an IP-based network. The method includes sending media data packets from the originating IP terminal to an intermediate address translation function in the network, the media data packets including the IP address of the originating IP terminal as a source address, and an IP address for the address translation function as a destination address. When the media data packets are received by the address translation function, the address translation function translates the source address from the IP address of the originating IP terminal to the IP address for the address translation function. The address translation function also translates the destination address from the IP address for the address translation function to an IP address for the terminating IP terminal. The translated media data packets are then sent from the address translation function to the terminating IP terminal. The translated data packets include the IP address for the address translation function as a source address, thereby hiding the identity of the originating IP terminal.

The method may also include the terminating IP terminal sending return media data packets to the address translation function, the return data packets including the IP address for the terminating IP terminal as a source address, and the IP address for the address translation function as a destination address. After the address translation function receives the return media data packets from the terminating IP terminal, it translates the destination address from the IP address for the address translation function to an IP address for the originating IP terminal, and sends the translated return media data packets to the originating IP terminal. The translated return data packets include the IP address for the terminating IP terminal as a source address, and thus, in this scenario, the identity of the terminating IP terminal is not hidden from the originating IP terminal.

Alternatively, the terminating IP terminal may wish to hide its IP address from the originating IP terminal. In this case, an address translation function in the home network of the terminating IP terminal replaces the source address of the terminating IP terminal with the IP address of the address translation function. If both terminals wish to hide their identities, then two address translation functions are utilized, one in each terminal's home network. Each address translation function replaces the source addresses of the terminal in its network with the IP address of the respective address translation function.

In another aspect, the present invention is a method of setting up a multimedia session in an IP-based network in which an IP address of an originating IP terminal is hidden from a terminating IP terminal. The method includes the steps of setting up an address translation function in the network that includes an address translation table; receiving an Invite message in the address translation function that identifies a source address to be used in media data packets during the multimedia session; and recognizing the IP address of the originating IP terminal as the source address. The address translation function associates the source address with an IP address of the address translation function and stores the IP address of the address translation function with the source address in the address translation table. The address translation function then sends the IP address for the address translation function to the originating IP terminal, and instructs the originating IP terminal to utilize the IP address for the address translation function as the destination address for the media data packets. The address translation function also sends the IP address for the address translation function to the terminating IP terminal, and instructs the terminating IP terminal to utilize the IP address for the address translation function as the destination address for return media data packets.

In another aspect, the present invention is a method of using an address translation function to hide an IP address of an originating IP terminal from a terminating IP terminal, and/or vice versa, during a multimedia session in an IP-based network. The method includes receiving in the address translation function, media data packets from the originating IP terminal that include the IP address of the originating IP terminal as a source address, and an IP address of the address translation function as a destination address. The address translation function translates the source address from the IP address of the originating IP terminal to the IP address for the address translation function, and translates the destination address from the IP address for the address translation function to the IP address of the terminating IP terminal. The address translation function then sends translated media data packets to the terminating IP terminal, the translated media data packets including the IP address of the address translation function as the source address. Return media data packets are therefore routed back to the media translation function which translates the destination address from the IP address for the address translation function to the IP address of the originating IP terminal. The address translation function then sends translated return media data packets to the originating IP terminal.

In another aspect, the invention is a system for hiding an IP address of an originating IP terminal from a terminating IP terminal, and/or vice versa, during a multimedia session in an IP-based network. The system includes a transmitter in the originating IP terminal that transmits media data packets from the originating IP terminal to an intermediate address translation function in the originating IP terminal's home network. The data packets include the IP address of the originating IP terminal as a source address, and include an IP address for the address translation function as a destination address. The system also includes an address translation table in the address translation function that translates the source address from the IP address of the originating IP terminal to the IP address for the address translation function. The address translation function also translates the destination address from the IP address for the address translation function to an IP address for the terminating IP terminal.

The system further includes a router in the address translation function that receives the media data packets from the originating IP terminal, and sends the translated media data packets to the terminating IP terminal. The translated media data packets include the IP address for the address translation function as the source address, thereby hiding the identity of the originating IP terminal from the terminating IP terminal.

In another aspect, the invention is a system for setting up a multimedia session in an IP-based network in which an IP address of an originating IP terminal is hidden from a terminating IP terminal, and/or vice versa. When hiding the IP address of the originating IP terminal, the system includes an address translation function in the originating IP terminal's home network that includes an address translation table that translates an IP address of the address translation function to an IP address of the terminating IP terminal. The address translation table also translates an IP address of the originating IP terminal to the IP address of the address translation function. The system further includes a signaling mechanism in the address translation function for sending the IP address for the address translation function to the originating IP terminal and instructing the originating IP terminal to utilize the IP address for the address translation function as the destination address for the media data packets. The signaling mechanism also sends the IP address for the address translation function to the terminating IP terminal and instructs the terminating IP terminal to utilize the IP address for the address translation function as the destination address for return media data packets. When hiding the IP address of the terminating IP terminal, the system includes an address translation function in the terminating IP terminal's home network that performs these functions in reverse.

In yet another aspect, the invention is an address translation function in an IP-based network for hiding an address of an originating IP terminal from a terminating IP terminal, and/or vice versa, during a multimedia session. The address translation function includes a signaling mechanism that sends an IP address of the address translation function to the originating IP terminal and to the terminating IP terminal during the setup of the multimedia session. The address translation function also includes a router that receives media data packets from the originating IP terminal, the media data packets including the IP address of the originating IP terminal as a source address, and the IP address of the address translation function as a destination address. The router also sends translated media data packets to the terminating IP terminal, the translated media data packets including the IP address of the address translation function as the source address, and the IP address of the terminating IP terminal as the destination address. The address translation function further includes an address translation table that translates the source address in the media data packets from the IP address of the originating IP terminal to the IP address for the address translation function, when hiding the IP address of the originating IP terminal. The table further translates the destination address from the IP address of the address translation function to the IP address of the terminating IP terminal. Return media data packets are routed back to the media translation function where the address translation table translates the destination address from the IP address for the address translation function to the IP address of the originating IP terminal. The address translation function then sends translated return media data packets to the originating IP terminal.

In yet another aspect, the present invention is a method of hiding an IP address of a terminating IP terminal from an originating IP terminal during a multimedia session in an IP-based network. The method includes the steps of receiving, by an address translation function in the home network of the terminating IP terminal, media data packets from the originating IP terminal, the media data packets including the IP address of the originating IP terminal as a source address, and an IP address of the address translation function as a destination address. The address translation function then translates the destination address from the IP address of the address translation function to the IP address of the terminating IP terminal, and sends translated media data packets to the terminating IP terminal. The translated media data packets include the IP address of the address translation function as the source address.

When the terminating IP terminal sends return media data packets, they are received by the address translation function. The return media data packets include the IP address of the terminating IP terminal as a source address, and the IP address of the address translation function as a destination address. The address translation function then translates the destination address in the return media data packets from the IP address of the address translation function to the IP address of the originating IP terminal. The address translation function also translates the source address in the return media data packets from the IP address of the terminating IP terminal to the IP address of the address translation function. The address translation function then sends translated return media data packets to the originating IP terminal. The translated media data packets include the IP address of the address translation function as the source address, thereby hiding the identity of the terminating IP terminal from the originating IP terminal.

In yet another aspect, the present invention is a method of hiding an IP address of an originating IP terminal from a terminating IP terminal, and hiding an IP address of the terminating IP terminal from the originating IP terminal during a multimedia session in an IP-based network. The method includes the steps of receiving media data packets from the originating IP terminal by a first address translation function in a home network of the originating IP terminal. The media data packets include the IP address of the originating IP terminal as a source address, and an IP address of the first address translation function as a destination address. The first address translation function translates the source address from the IP address of the originating IP terminal to the IP address of the first address translation function, and translates the destination address from the IP address of the first address translation function to the IP address of a second address translation function in a home network of the terminating IP terminal. The first address translation function then sends translated media data packets to the second address translation function, the translated media data packets including the IP address of the first address translation function as the source address.

The second address translation function then translates the source address from the IP address of the first address translation function to the IP address of the second address translation function, and translates the destination address from the IP address of the second address translation function to the IP address of the terminating IP terminal. The second address translation function then sends translated media data packets to the terminating IP terminal, the translated media data packets including the IP address of the second address translation function as the source address, thus hiding the identity of the originating IP terminal from the terminating IP terminal.

When the terminating IP terminal sends return media data packets, they are received by the second address translation function. The return media data packets include the IP address of the terminating IP terminal as a source address, and the IP address of the second address translation function as a destination address. The second address translation function then translates the source address in the return media data packets from the IP address of the terminating IP terminal to the IP address of the second address translation function. The second address translation function also translates the destination address in the return media data packets from the IP address of the second address translation function to the IP address of the first address translation function. The second address translation function then sends translated return media data packets to the first address translation function, the translated return media data packets including the IP address of the second address translation function as the source address.

The first address translation function translates the source address in the translated return media data packets from the IP address of the second address translation function to the IP address of the first address translation function. The first address translation function also translates the destination address in the translated return media data packets from the IP address of the first address translation function to the IP address of the originating IP terminal. Finally, the first address translation function sends translated return media data packets to the originating IP terminal, the translated media data packets including the IP address of the first address translation function as the source address, thus hiding the identity of the terminating IP terminal from the originating IP terminal.

### BRIEF DESCRIPTION OF THE DRAWINGS

The invention will be better understood and its numerous objects and advantages will become more apparent to those skilled in the art by reference to the following drawings, in conjunction with the accompanying specification, in which:

FIG. 1 is a signaling diagram illustrating the flow of control messages between the nodes of an IP-based multimedia network when setting up a multimedia session to hide an originating IP terminal's IP address in accordance with the teachings of the present invention;

FIG. 2 is a simplified block diagram of the flow of control messages through the control portion of a Media Resource Function (MRF-C) when setting up a multimedia session in accordance with the signaling diagram of FIG. 1;

FIG. 3 is a simplified block diagram of the media flow through the media portion of a Media Resource Function (MRF-M) located in the originating subscriber's home network during a multimedia session in which the IP address of the originating Subscriber-A is hidden from the terminating Subscriber-B;

FIG. 4 is a simplified block diagram of the media flow through an MRF-M located in the terminating subscriber's home network during a multimedia session in which the IP address of the terminating Subscriber-B is hidden from the originating Subscriber-A; and

FIG. 5 is a simplified block diagram of the media flow through an MRF-M in the originating subscriber's home network and an MRF-M in the terminating subscriber's home network during a multimedia session in which the IP addresses of both subscribers are hidden from each other.

### DETAILED DESCRIPTION OF EMBODIMENTS

The present invention is a system and method for hiding a source IP address by routing IP media packets through an entity that removes the source address and substitutes an alias address. The entity is called a Media Resource Function (MRF). The MRF performs an address translation. It maps the source address to the alias address in the IP packets, and then forwards the packets to the destination user. The destination user sees only the alias address as the source address for the packets and, therefore, routes return packets to the MRF. When the packets come back in the opposite direction, the MRF removes the alias address and substitutes the original source address as the destination address. The MRF then forwards the packets to the source user.

Control signaling is required between the source user, the destination user, and the MRF to invoke the service and set up the session. The signaling messages convey the real source address to the MRF so that it can make the proper translation prior to forwarding the packets to the destination user. The MRF is located in the home network of the user that wants to hide his address.

Further, an appealing aspect of the present invention is that the current architecture of the 3GPP network does not need to be changed to implement the present invention.

The present invention is described herein primarily in terms of the Session Initiation Protocol (SIP) developed by the Internet Engineering Task Force (IETF), but is equally applicable to the International Telecommunications Union (ITU) H.323 protocol, or other packet-switched control protocols. In a typical IP network, PC clients or IP telephony terminals (fixed or mobile) are identified and addressed by an e-mail address (proxy/alias), or an IP address or both. The present invention makes a substitution for this identifying address, regardless of the specific protocol.

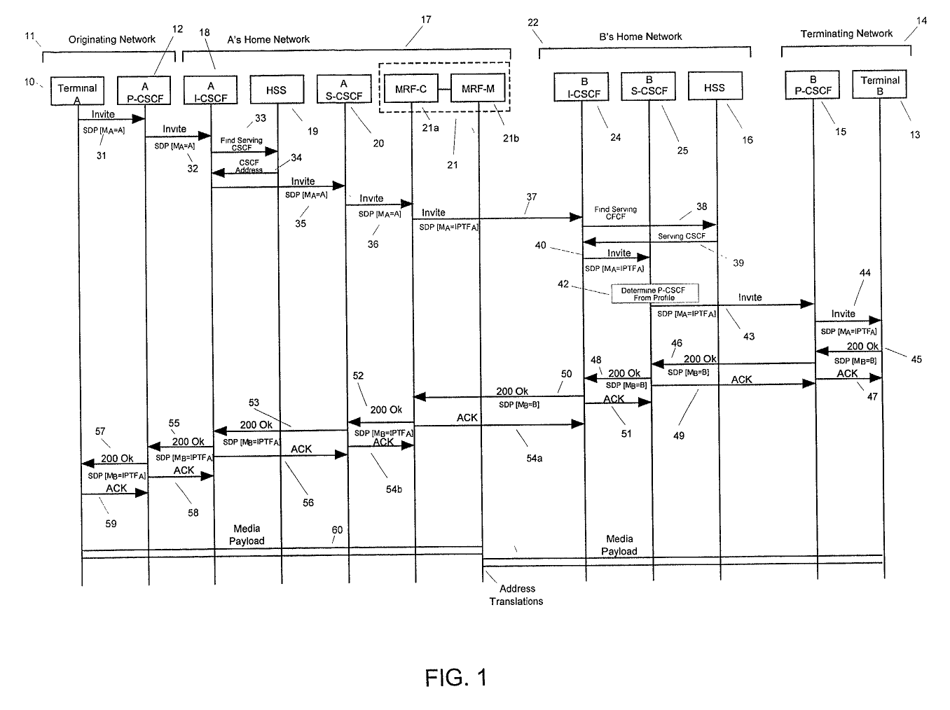

Table 1 below is an exemplary address translation table implemented within an MRF in the home network of Subscriber-A who wishes to have his IP address hidden when Subscriber-A originates a multimedia session with a terminating Subscriber-B. In this scenario, the IP address of the terminating Subscriber-B is not hidden from Subscriber-A. The translation table includes multiple entries and is indexed by the address in the source address field in the IP header of media packets received in the MRF. Each entry includes the actions to be performed by the address translation function on the source and destination IP addresses in the incoming packets. The actions include either performing an address translation or passing an address through unchanged, depending on the entry in the table. If an address translation is performed, the address is mapped to the address stored in the entry. An example illustrating the use of Table 1 is described in conjunction with FIGS. 1-3.

TABLE 1

| INDEX | TRANSLATE SOURCE TO: | TRANSLATE DEST. TO: |
|---|---|---|
| A | S = IPTF_{A} | D = B |
| B | S = B (UNCHANGED) | D = A |
| . . . | . . . | . . . |

FIG. 1 is a signaling diagram illustrating the flow of control messages between the nodes of an IP-based multimedia network when setting up a multimedia session to hide the originating subscriber's IP address in accordance with the teachings of the present invention. Terminal-A 10 is operating in an originating network 11 that includes a Proxy Call State Control Function (P-CSCF) 12. Terminal-A 10 is originating a session towards Terminal-B 13. Terminal-B is in a terminating network 14 that also includes a Proxy CSCF (P-CSCF) 15. Terminal-A has a home network 17 that includes an Interrogating CSCF (I-CSCF) 18, a Home Subscriber Server (HSS) 19 and a Serving CSCF (S-CSCF) 20. Terminal-B's home network 22 includes an Interrogating CSCF (I-CSCF) 24, a Serving CSCF (S-CSCF) 25, and a Home Subscriber Server (HSS) 16.

The present invention extends the functionality of a Media Resource Function (MRF) 21 in Terminal-A's home network to perform the address hiding function. The MRF functionally comprises a control portion (MRF-C) 21a and a media portion (MRF-M) 21b. The MRF functions as an intermediate address translation function between Terminal-A and Terminal-B.

Terminal-A 10 sends a SIP Invite message 31 to the P-CSCF 12. The Invite message includes the Session Description Protocol (SDP) for that session which includes the IP Media address used by Terminal-A. The address is denoted herein by M_{A}=A, where A is the IP media address of Terminal-A. The P-CSCF 12 forwards the invite message at 32 to the I-CSCF 18. The I-CSCF 18 sends a query 33 to Terminal A's HSS 19 requesting the identity of Terminal A's Serving CSCF. The address of the S-CSCF 20 is returned to the I-CSCF at 34. The I-CSCF 18 then sends a SIP Invite message 35 to the S-CSCF 20. The S-CSCF checks Subscriber-A's subscriber profile and determines that Subscriber-A subscribes to the hidden identity feature. At 36, since Subscriber-A subscribes to the hidden identity feature, the S-CSCF sends an Invite message to MRF-C 21a. The MRF-C, in turn, creates an entry in the address translation table (Table 1) that is indexed with the media end point address of Terminal-A, and stores an action that results in mapping Terminal-A's IP address to the IP address of the MRF Address Translation Function (IPTF_{A}). This is denoted in Table 1 by the entry S=IPTF_{A} where S stands for mapping the source address in the IP packet. The MRF-C then sends an Invite message 37 to the I-CSCF 24 in B's home network 22. The MRF-C includes IPTF_{A} as the source media IP end point address in the SDP included in the Invite message instead of the IP media address of Terminal-A.

At 38, the I-CSCF 24 sends a query to the HSS 16 in Terminal-B's home network 14 to find Terminal-B's serving CSCF. At 39, the identity of Terminal-B's serving CSCF is returned from the HSS to the I-CSCF 24. At 40, the I-CSCF sends an Invite message to the S-CSCF 25. The S-CSCF determines the location of the subscriber from the address of the visited P-CSCF 15 in the subscriber profile at step 42. The S-CSCF 25 then sends an Invite message 43 to the P-CSCF 15. The Invite message is then forwarded to Terminal-B at 44.

Terminal-B responds with a SIP 200 OK message at 45. The SDP embedded within the 200 OK message includes the media IP end point address of Terminal-B. This is denoted herein by M_{B}=B where B is the IP media address for Terminal-B. The P-CSCF 15 forwards the 200 OK message to the S-CSCF 25 in B's home network at 46 and sends an Acknowledgment 47 back to Terminal-B. The S-CSCF 25 sends the 200 OK message to Terminal-B's I-CSCF 24 at 48 and sends an Acknowledgment 49 back to the P-CSCF 15. The I-CSCF 24 sends the 200 OK message to the MRF-C 21a at 50 and sends an Acknowledgment 51 back the S-CSCF.

The MRF-C replaces the media IP end point address of Terminal-B that is included in the SDP embedded within the SIP 200 OK message with the IP address of the MRF Address Translation Function (IPTF_{A}) prior to proxying that to the next hop. At the same time, the MRF-C creates a new entry in the address translation table that is indexed with the media end point address of Terminal-B as the source address in incoming IP media packets.

As shown in Table 1, for each IP media packet received in the MRF whose source address includes the media end point of Terminal-B, the entry causes the MRF to replace the destination address (in the IP header) for that packet with the media end point IP address of Terminal-A prior to the packet leaving the MRF. The source address (Terminal-B) is left unchanged. In addition, the MRF-C identifies the entry indexed by the media end point IP address of Terminal-A, and updates it with the media end point address of Terminal-B (for mapping of the destination address in incoming media packets as previously described). The MRF-C is able to make the correlation between the various addresses that need to be replaced because it is stateful when it comes to SIP sessions.

AT 52, the MRF-C 21a sends the 200 OK message to the S-CSCF 20 in Terminal-A's home network, and sends an Acknowledgment 54a to the I-CSCF 24 in B's home network. The S-CSCF 20 forwards the 200 OK message at 53 to Terminal-A's I-CSCF 18 and sends an Acknowledgment 54b back to the MRF-C. At 55, the I-CSCF 18 sends the 200 OK message to the P-CSCF 12 in the originating network and sends an Acknowledgment 56 back to the S-CSCF 20. At 57, the P-CSCF 12 sends the 200 OK message to Terminal-A 10 and returns an Acknowledgment 58 to the I-CSCF 18. Finally, at 59, Terminal-A sends an Acknowledgment to the P-CSCF 12.

The 200 OK message instructs Terminal-A to utilize the IP address of the MRF Address Translation Function (IPTF_{A}) as the destination address when communicating with Terminal-B for the purpose of media exchange, thus ensuring that Terminal-A's media is forwarded to the MRF 21. When the media payload begins to flow at 60, it is forwarded from Terminal-A to MRF-M 21b which performs address translations to forward the media to Terminal-B 13.

Alternatively, the MRF-C 21a may return the alias address (IPTF_{A}) in the SDP of any SIP response or command message generated toward either Terminal-A or Terminal-B. Hence, it is guaranteed that the media in both directions has to go through the MRF which performs the proper address translation.

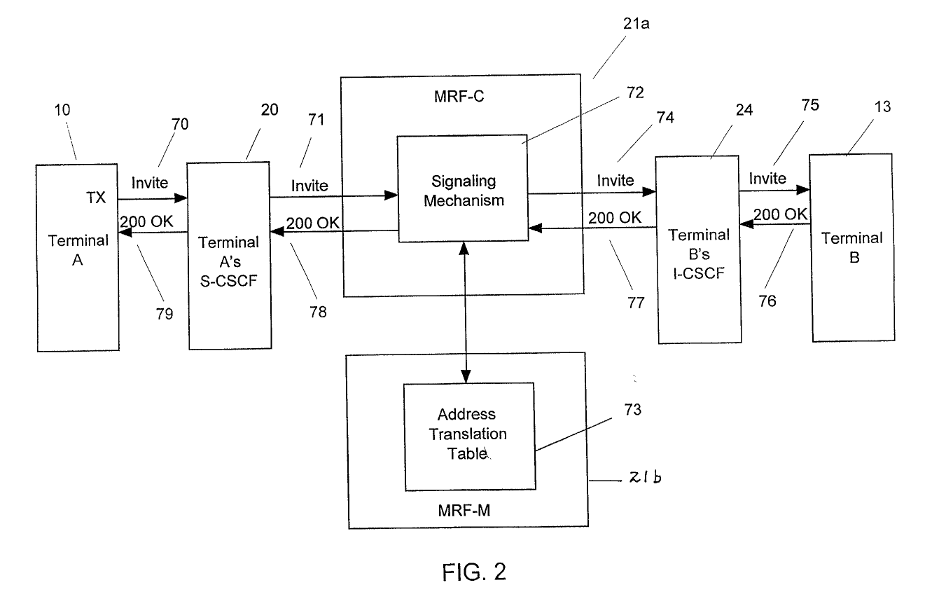

FIG. 2 is a simplified block diagram of the flow of control messages through the control portion of the MRF (MRF-C) 21a when setting up a multimedia session in which the IP address of the originating Subscriber-A is to be hidden. The entries in the address translation table 73 in the MRF are a direct result of the session signaling. Logic in the signaling mechanism 72 that handles the signaling also creates the entries in the address translation table. The setup begins when Terminal-A 10 transmits an Invite message directed towards Terminal-B at step 70. After routing in Terminal-A's home network 17 as described in FIG. 1, Terminal-A's S-CSCF 20 receives the message and sends it, at step 71, to the MRF-C 21a. In the MRC-C 21a, the signaling mechanism 72 receives the Invite message and creates an entry in the address translation table 73 in MRF-M 21b to translate Terminal-A's IP address to IPTF_{A}. IPTF_{A} is then substituted as the IP media address in the SDP included in the Invite message. At step 74, the signaling mechanism routes the Invite message to Terminal-B's I-CSCF 24 in Terminal-B's home network. After routing in Terminal-B's home network as described in FIG. 1, Terminal-B's I-CSCF 24 then sends the message at 75 to Terminal-B 13.

At 76, Terminal-B then transmits a response 200 OK message and includes its IP media address in the SDP embedded therein. At step 77, Terminal-B's I-CSCF then routes the 200 OK message to the signaling mechanism in the MRF-C 21a. Once again, the signaling mechanism creates an entry in the address translation table 73 in the MRF-M to translate the IP address of Terminal-B to IPTF_{A}, which is then placed in the SDP in the 200 OK message to instruct Terminal-A to use IPTF_{A} as the destination address for any packets sent to Terminal-B. At 78, the signaling mechanism then sends the 200 OK message to Terminal-A's S-CSCF 20 which forwards it to Terminal-A at 79.

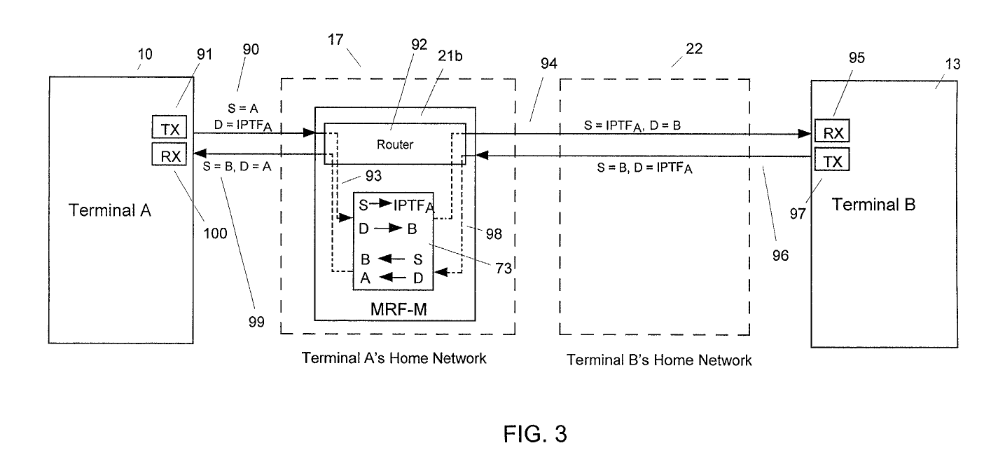

FIG. 3 is a simplified block diagram of the media flow through the media portion of the MRF (MRF-M) 21b during a multimedia session in an IP network in which the IP address of the originating Subscriber-A is hidden from the terminating Subscriber-B. At step 90, media traffic originates from Terminal-A's transmitter 91. The media packets have as their source address, the IP address of Terminal-A, and have a destination address of IPTF_{A} (as passed to Terminal-A during setup of the session). The media traffic flows to a router 92 in the MRF-M in Terminal-A's home network 17. At step 93, the media traffic is routed to the address table 73. As shown in Table 1, the address table is indexed to recognize the source address of Terminal-A, and in response, to map Terminal-A's source IP address to a new alias IP address, IPTF_{A}. The MRF-M also translates the destination address from IPTF_{A} to the destination address of Terminal-B. At step 94, the media packets are then sent to Terminal-B 13 indicating the alias address IPTF_{A}, as the source IP address. The media packets are received by Terminal-B's receiver 95 and are processed by Terminal-B.

When Terminal-B 13 addresses return media packets at step 96, the return media packets are sent by Terminal-B's transmitter 97, and IPTF_{A} is used as the destination address. The IP address of Terminal-B is used as the source address. The media traffic flows from Terminal-B to the router 92 in MRF-M 21b in Terminal-A's home network 17. At step 98, the media traffic is routed to the address table 73 which, as shown in Table 1, is indexed to recognize the source address of Terminal-B, and in response, to map the destination address from IPTF_{A} to the IP address for Terminal-A. The source IP address for Terminal-B is passed through unchanged. At step 99, the media then flows to Terminal-A 10 and is received by the receiver 100.

In the case in which the terminating Subscriber-B is the one that has subscribed to the address hiding feature rather than the originating Subscriber-A, the MRF performing the address translation is located in the home network of the terminating Subscriber-B, as opposed to the home network of the originating Subscriber-A. The signaling and actions taken by the different network entities is identical to the originating subscriber case.

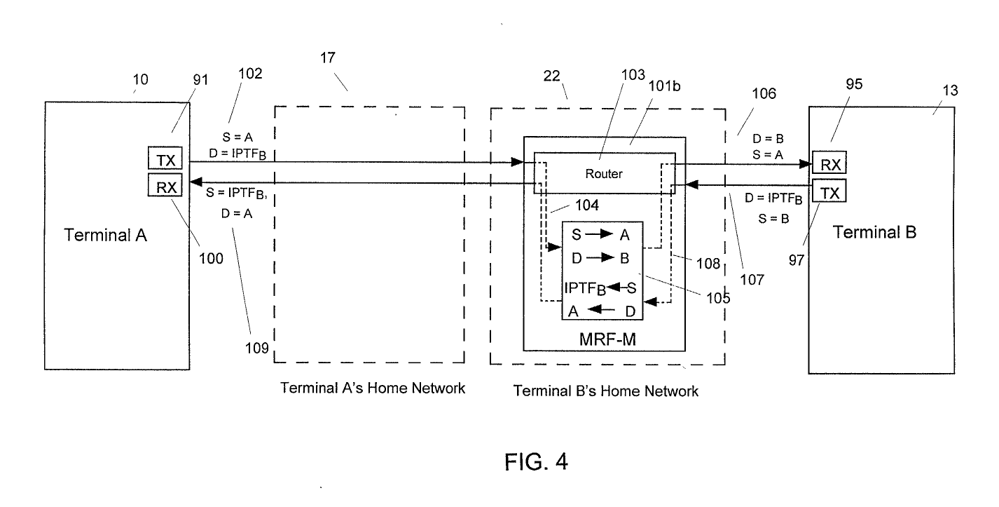

Table 2 below is an exemplary address translation table implemented within an MRF in the home network of the terminating Subscriber-B who wishes to have his IP address hidden when Subscriber-A originates a multimedia session with Subscriber-B. In this scenario, the IP address of the originating Subscriber-A is not hidden from Subscriber-B. Once again, the translation table includes multiple entries and is indexed by the address in the source address field in the IP header of media packets received in the MRF. Each entry includes the actions to be performed by the address translation function on the source and destination IP addresses in the incoming packets. The actions include either performing an address translation or passing an address through unchanged, depending on the entry in the table. If an address translation is performed, the address is mapped to the address stored in the entry. An example illustrating the use of Table 2 is described in conjunction with FIG. 4.

TABLE 2

| INDEX | TRANSLATE SOURCE TO: | TRANSLATE DEST. TO: |
|---|---|---|
| A | S = A (UNCHANGED) | D = B |
| B | S = IPTF_{A} | D = A |
| . . . | . . . | . . . |

FIG. 4 is a simplified block diagram of the media flow through the Media Portion of an MRF (MRF-M) 101b located in the terminating subscriber's home network 22 during a multimedia session in which the IP address of the terminating Subscriber-B is hidden from the originating Subscriber-A. At step 102, media traffic originates from Terminal-A's transmitter 91. The media packets have as their source address, the IP address of Terminal-A, and have a destination address of IPTF_{B}. The media traffic flows to the router 103 in MRF-M 101b in Terminal-B's home network. At step 104, the media traffic is routed to the address table 105 (see Table 2) which is indexed to recognize the source address of Terminal-A, and in response, to pass Terminal-A's source IP address through unchanged while translating the destination address from IPTF_{B} to the destination address of Terminal-B. At step 106, the media packets are then sent to Terminal-B 13 indicating the IP address for Terminal-A as the source IP address. The media packets are received by Terminal-B's receiver 95 and are processed by Terminal-B.

When Terminal-B 13 addresses return media packets in response at step 107, IPTF_{B} is used as the destination address, and the IP address of Terminal-B is used as the source address. The media traffic flows from Terminal-B to the router 103 in MRF-M 101b in Terminal-B's home network 22. At step 108, the media traffic is routed to the address table 105 (Table 2) which is indexed to recognize the source address of Terminal-B, and in response, to translating the source address to IPTF_{B} while translating the destination address from IPTF_{B} to the IP address of Terminal-A. At step 109, the media then flows to Terminal-A 10 and is received by the receiver 100.

If both the originating and the terminating subscribers have subscribed to the address hiding feature, and belong to the same operator, two MRFs are engaged to perform address translations, one in the home network of each subscriber. The signaling in this case, as well as the actions taken by the different entities, does not change. The MRF in the originating subscriber's home network is treated like Terminal-A from the perspective of the MRF in the terminating subscriber's home network, and the MRF in the terminating subscriber's home network is treated like Terminal-B from the perspective of the MRF in the originating subscriber's home network.

Table 3 below is an exemplary address translation table implemented within an MRF in the home network of originating Subscriber-A when both the originating Subscriber-A and terminating Subscriber-B desire to have their addresses hidden from the other party. Table 3 includes multiple entries and is indexed by the address in the source address field in the IP header of media packets received in the MRF. Each entry includes the actions to be performed by the address translation function on the source and destination IP addresses in the incoming packets. The actions include either performing an address translation or passing an address through unchanged, depending on the entry in the table. If an address translation is performed, the address is mapped to the address stored in the entry.

TABLE 3

| INDEX | TRANSLATE SOURCE TO: | TRANSLATE DEST. TO: |
|---|---|---|
| A | S = IPTF_{A} | D = IPTF_{B} |
| IPTF_{B} | S = IPTF_{A} | D = A |
| . . . | . . . | . . . |

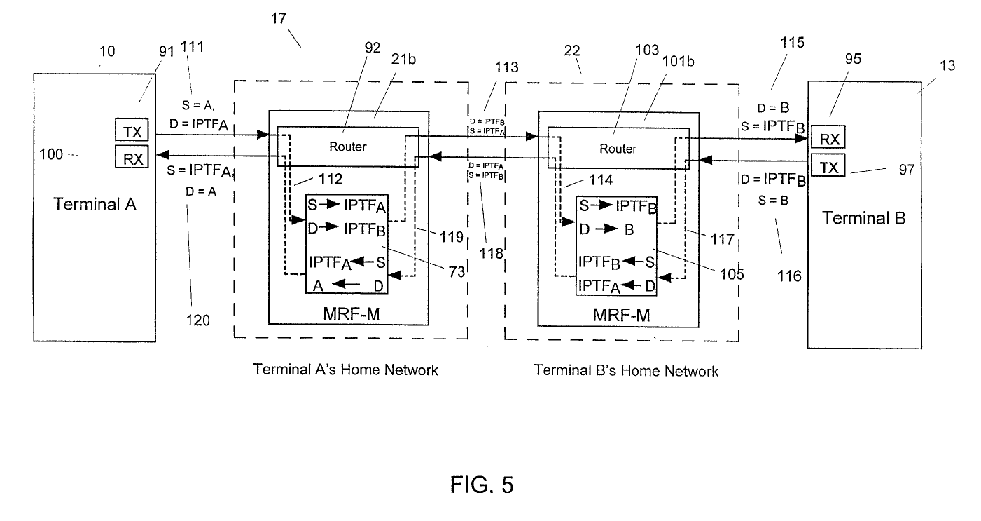

Table 4 below is an exemplary address translation table implemented within an MRF in the home network of the terminating Subscriber-B when both the originating Subscriber-A and terminating Subscriber-B desire to have their addresses hidden from the other party. Table 4 includes multiple entries and is indexed by the address in the source address field in the IP header of media packets received in the MRF. Each entry includes the actions to be performed by the address translation function on the source and destination IP addresses in the incoming packets. The actions include either performing an address translation or passing an address through unchanged, depending on the entry in the table. If an address translation is performed, the address is mapped to the address stored in the entry. An example illustrating the use of Tables 3 and 4 is described in conjunction with FIG. 5.

TABLE 4

| INDEX | TRANSLATE SOURCE TO: | TRANSLATE DEST. TO: |
|---|---|---|
| IPTF_{A} | S = IPTF_{B} | D = B |
| B | S = IPTF_{B} | D = IPTF_{A} |
| . . . | . . . | . . . |

The two MRFs need not be two physically separate entities. They can be two different logical entities within a single physical MRF from a signaling point of view. Hence, all entities behave the same as when a single address is being hidden (i.e., either that of Terminal-A or Terminal-B), with the exception of the MRF-C functionality which is extended as follows:

If the MRF-C realizes upon receipt of an Invite message from the S-CSCF of the terminating subscriber that it is already engaged to hide the originating subscriber's IP address, the MRF-C sets a flag in the session record to that effect.

When the SIP response message from Terminal-B, including the SDP carrying the media end point IP address of Terminal-B, is received by the MRF, the entry indexed by that address has a supplementary action in addition to what has been previously described. For all IP media packets arriving at the MRF whose source address matches the media end point address of Terminal-B, the supplementary action includes translating the source address to the IP address of the MRF address translation function (instead of performing no translation as in the case of a single address being hidden).

FIG. 5 is a simplified block diagram of the media flow through the MRF-M 21b in the originating subscriber's home network and the MRF-M 101b in the terminating subscriber's home network during a multimedia session in which the IP addresses of both subscribers are hidden from the other subscriber. At step 111, media traffic originates from Terminal-A's transmitter 91. The media packets have as their source address, the IP address of Terminal-A, and have a destination address of IPTF_{A}. The media traffic flows to the router 92 in MRF-M 21b in Terminal-A's home network 17. At step 112, the media traffic is routed to the address table 73 (see Table 3) which is indexed to recognize Terminal-A's source IP address, and in response, to map the source address to IPTF_{A}. The destination address is mapped from IPTF_{A} to IPTF_{B}. At step 113, the media packets are then sent to MRF-M 101b in Terminal-Bs home network 22.

At step 114, MRF-M 101b uses the address table 105 (see Table 4) to map the source address from IPTF_{A} to IPTF_{B}, and to map the destination address from IPTF_{B} to the IP address for Terminal-B. At step 115, the media packets are then sent to Terminal-B 13 indicating IPTF_{B} as the source IP address. The media packets are received by Terminal-B's receiver 95 and are processed by Terminal-B.

When Terminal-B 13 addresses media packets in response at step 116, IPTF_{B} is used as the destination address, and the IP address of Terminal-B is used as the source address. The media traffic flows from Terminal-B to the router 103 in MRF-M 101b. At step 117, the address table 105 (Table 4) is used to map the destination address from IPTF_{B} to IPTF_{A}, and to map the source address from the IP address for Terminal-B to IPTF_{B}. At step 118, the media packets are then sent to MRF-M 21b in Terminal-As home network 17. At step 119, MRF-M 21b uses the address translation table 73 (Table 3) to map the source address from IPTF_{B} to IPTF_{A}, and to map the destination address from IPTF_{A} to the IP address for Terminal-A. At 120, the media then flows to Terminal-A 10 and is received by the receiver 100.

Once a media session is cleared, whether one address is being hidden or both addresses are being hidden, all of the entries in the address translation table(s) are erased. New entries are created when a new session is set up, and one or both of the parties requests that their address be hidden.

It is thus believed that the operation and construction of the present invention will be apparent from the foregoing description. While the method, apparatus and system shown and described has been characterized as being preferred, it will be readily apparent that various changes and modifications could be made therein without departing from the scope of the invention as defined in the following claims.

What is claimed is:

1. A method of hiding an Internet Protocol (IP) address of an originating IP terminal from a terminating IP terminal during a multimedia session in an IP-based network, said method comprising the steps of:
sending media data packets from the originating IP terminal to an intermediate address translation function in the network, said data packets including an IP address of the originating IP terminal as a source address, and an IP address for the address translation function as a destination address;
receiving the media data packets from the originating IP terminal in the address translation function;
translating, by the address translation function, the source address from the IP address of the originating IP terminal to the IP address for the address translation function;
translating, by the address translation function, the destination address from the IP address for the address translation function to an IP address for the terminating IP terminal; and
sending the translated media data packets from the address translation function to the terminating IP terminal, said translated data packets including the IP address for the address translation function as a source address, and the IP address for the terminating IP terminal as a destination address.

2. The method of hiding an IP address of an originating IP terminal from a terminating IP terminal of claim 1 wherein the step of sending media data packets from the originating IP terminal to an intermediate address translation function includes sending the data packets to a Media Resource Function (MRF) that includes address translation tables.

3. The method of hiding an IP address of an originating IP terminal from a terminating IP terminal of claim 1 further comprising, before the step of sending media data packets from the originating IP terminal to the intermediate address translation function, the step of sending the IP address for the address translation function to the originating IP terminal and the terminating IP terminal during setup of the multimedia session.

4. The method of hiding an IP address of an originating IP terminal from a terminating IP terminal of claim 1 further comprising the steps of:
sending return media data packets from the terminating IP terminal to the address translation function, said return data packets including the IP address for the terminating IP terminal as a source address, and the IP address for the address translation function as a destination address;
receiving the return media data packets from the terminating IP terminal in the address translation function;
translating, by the address translation function, the destination address from the IP address for the address translation function to the IP address for the originating IP terminal; and
sending translated returned media data packets from the address translation function to the originating IP terminal, said translated returned data packets including the IP address for the terminating IP terminal as a source address, and the IP address for the originating IP terminal as a destination address.

5. The method of hiding an IP address of an originating IP terminal from a terminating IP terminal of claim 4 further comprising the steps of:
sending the IP address for the address translation function to the originating IP terminal during setup of the multimedia session, the originating IP terminal being instructed to utilize the IP address for the address translation function as the destination address for the media data packets; and
sending the IP address for the address translation function to the terminating IP terminal during setup of the multimedia session, the terminating IP terminal being instructed to utilize the IP address for the address translation function as the destination address for the return media data packets.

6. A method of setting up a multimedia session in an Internet Protocol (IP)-based network in which an IP address of an originating IP terminal is hidden from a terminating IP terminal, said method comprising the steps of:
setting up an address translation function in the network that includes an address translation table;
receiving an Invite message in the address translation function that identifies an IP media address of the originating IP terminal;
receiving a response message in the address translation function that identifies an IP media address of the terminating IP terminal;
storing in the address translation table, instructions to translate the source address in media data packets having the IP media address of the originating IP terminal as a source address to the IP address of the address translation function, and to translate the destination address to the IP media address of the terminating IP terminal;
sending the IP address for the address translation function to the originating IP terminal, the originating IP terminal being instructed to utilize the IP address for the address translation function as the destination address for the media data packets; and
sending the IP address for the address translation function to the terminating IP terminal, the terminating IP terminal being instructed to utilize the IP address for the address translation function as the destination address for return media data packets.

7. The method of setting up a multimedia session in an IP-based network of claim 6 further comprising storing in the address translation table, instructions to translate the destination address in media data packets having the IP media address of the terminating IP terminal as a source address to the IP media address of the originating IP terminal while leaving the source address unchanged.

8. The method of setting up a multimedia session in an IP-based network of claim 7 further comprising deleting the translation instructions from the address translation table when the multimedia session is cleared.

9. The method of setting up a multimedia session in an IP-based network of claim 6 further comprising the steps of:
sending an Invite message from the originating IP terminal to the originating IP terminal's home network;
determining in the originating IP terminal's home network, whether the originating IP terminal subscribes to a hidden identity feature; and
routing the origination message to the address translation function, upon determining that the originating IP terminal subscribes to the hidden identity feature.

10. A method of hiding an Internet Protocol (IP) address of an originating IP terminal from a terminating IP terminal during a multimedia session in an IP-based network, said method comprising the steps of:
receiving, by an address translation function in the network, media data packets from the originating IP terminal, said media data packets including the IP address of the originating IP terminal as a source address, and an IP address of the address translation function as a destination address;
translating, by the address translation function, the source address from the IP address of the originating IP terminal to the IP address for the address translation function; and
sending, by the address translation function, translated media data packets to the terminating IP terminal, said translated media data packets including the IP address of the address translation function as the source address.

11. The method of hiding an IP address of an originating IP terminal from a terminating IP terminal of claim 10 wherein the address translation function is a Media Resource Function (MRF), and the method further comprises setting up address translation tables in the MRF.

12. The method of hiding an IP address of an originating IP terminal from a terminating IP terminal of claim 10 further comprising, before the step of receiving media data packets in the address translation function from the originating IP terminal, the step of sending the IP address for the address translation function to the originating IP terminal and the terminating IP terminal during setup of the multimedia session.

13. The method of hiding an IP address of an originating IP terminal from a terminating IP terminal of claim 10 further comprising the steps of:
receiving, by the address translation function, return media data packets from the terminating IP terminal, said return media data packets including the IP address for the address translation function as the destination address;
translating, by the address translation function, the IP address for the address translation function to the IP address for the originating IP terminal; and
sending, by the address translation function, translated return media data packets to the originating IP terminal, said translated return media data packets including the IP address for the terminating IP terminal as the source address, and the IP address of the originating IP terminal as the destination address.

14. A system for hiding an Internet Protocol (IP) address of an originating IP terminal from a terminating IP terminal during a multimedia session in an IP-based network, said system comprising:
a transmitter in the originating IP terminal that transmits media data packets from the originating IP terminal to an intermediate address translation function in the originating IP terminal's home network, said data packets including the IP address of the originating IP terminal as a source address, and an IP address for the address translation function as a destination address;
an address translation table in the address translation function, that translates the source address from the IP address of the originating IP terminal to the IP address for the address translation function, and that translates the destination address from the IP address for the address translation function to an IP address for the terminating IP terminal; and
a router in the address translation function that receives the media data packets from the originating IP terminal, and sends translated media data packets to the terminating IP terminal, said translated data packets including the IP address for the address translation function as the source address, and the IP address for the terminating IP terminal as the destination address.

15. The system for hiding an IP address of an originating IP terminal from a terminating IP terminal of claim 14 wherein the address translation function is a Media Resource Function (MRF).

16. The system for hiding an IP address of an originating IP terminal from a terminating IP terminal of claim 14 further comprising a signaling mechanism in the address translation function that sends the IP address for the address translation function to the originating IP terminal and the terminating IP terminal during setup of the multimedia session.

17. A system for setting up a multimedia session in an Internet Protocol (IP)-based network in which an IP address of an originating IP terminal is hidden from a terminating IP terminal, said system comprising:
an address translation table in an address translation function in the originating IP terminal's home network, said table being indexed to recognize the IP address of the originating IP terminal as a source address, and in response, said table translating the source address from the IP address of the originating IP terminal to an IP address of the address translation function; and
a signaling mechanism in the address translation function for:
obtaining an IP address of the terminating IP terminal;
sending the IP address for the address translation function to the originating IP terminal, the originating IP terminal being instructed to utilize the IP address for the address translation function as the destination address for the media data packets; and
sending the IP address for the address translation function to the terminating IP terminal, the terminating IP terminal being instructed to utilize the IP address for the address translation function as the destination address for return media data packets.

18. The system for setting up a multimedia session of claim 17 further comprising:
a transmitter in the originating IP terminal for sending an origination message from the originating IP terminal to the originating IP terminal's home network; and
a Serving Call State Control Function (S-CSCF) in the originating IP terminal's home network that determines whether the originating IP terminal subscribes to a hidden identity feature, and that routes the origination message to the address translation function, upon determining that the originating IP terminal subscribes to the hidden identity feature.

19. An address translation function in an Internet Protocol (IP)-based network for hiding an address of an originating IP terminal from a terminating IP terminal during a multimedia session, said address translation function comprising:
a signaling mechanism that sends an IP address of the address translation function to the originating IP terminal and the terminating IP terminal during setup of the multimedia session;
a router that receives media data packets from the originating IP terminal, said media data packets including the IP address of the originating IP terminal as a source address, and the IP address of the address translation function as a destination address, said router also sending translated media data packets to the terminating IP terminal, said translated media data packets including the IP address of the address translation function as the source address; and
an address translation table that translates the source address in the media data packets from the IP address of the originating IP terminal to the IP address for the address translation function, and translates the destination address from the IP address of the address translation function to the IP address of the terminating IP terminal.

20. The address translation function of claim 19 wherein the router also receives return media data packets from the terminating IP terminal, said return media data packets including the IP address of the terminating IP terminal as a source address, and the IP address of the address translation function as a destination address, said router also sending translated return media data packets to the originating IP terminal, said translated return media data packets including the IP address of the terminating IP terminal as the source address, and the IP address of the originating IP terminal as a destination address.

21. The address translation function of claim 19 wherein the address translation table leaves the source address in the return media data packets unchanged, and translates the destination address in the return media data packets from the IP address of the address translation function to the IP address of the originating IP terminal.

22. A method of hiding an Internet Protocol (IP) address of a terminating IP terminal from an originating IP terminal during a multimedia session in an IP-based network, said method comprising the steps of:
receiving, by an address translation function in the home network of the terminating IP terminal, media data packets from the originating IP terminal, said media data packets including the IP address of the originating IP terminal as a source address, and an IP address of the address translation function as a destination address;
translating, by the address translation function, the destination address from the IP address of the address translation function to the IP address of the terminating IP terminal;
sending, by the address translation function, translated media data packets to the terminating IP terminal;
receiving, by the address translation function, return media data packets from the terminating IP terminal, said return media data packets including the IP address of the terminating IP terminal as a source address, and the IP address of the address translation function as a destination address;
translating, by the address translation function, the destination address in the return media data packets from the IP address of the address translation function to the IP address of the originating IP terminal;
translating, by the address translation function, the source address in the return media data packets from the IP address of the terminating IP terminal to the IP address of the address translation function; and
sending, by the address translation function, translated return media data packets to the originating IP terminal, said translated media data packets including the IP address of the address translation function as the source address.

23. A method of hiding an Internet Protocol (IP) address of an originating IP terminal from a terminating IP terminal, and hiding an IP address of the terminating IP terminal from the originating IP terminal during a multimedia session in an IP-based network, said method comprising the steps of:
receiving, by a first address translation function in a home network of the originating IP terminal, media data packets from the originating IP terminal, said media data packets including the IP address of the originating IP terminal as a source address, and an IP address of the first address translation function as a destination address;
translating, by the first address translation function, the source address from the IP address of the originating IP terminal to the IP address of the first address translation function;
translating, by the first address translation function, the destination address from the IP address of the first address translation function to the IP address of a second address translation function in a home network of the terminating IP terminal;
sending, by the first address translation function, translated media data packets to the second address translation function, said translated media data packets including the IP address of the first address translation function as the source address;
translating, by the second address translation function, the source address from the IP address of the first address translation function to the IP address of the second address translation function;
translating, by the second address translation function, the destination address from the IP address of the second address translation function to the IP address of the terminating IP terminal;
sending, by the second address translation function, twice translated media data packets to the terminating IP terminal, said twice translated media data packets including the IP address of the second address translation function as the source address;
receiving, by the second address translation function, return media data packets from the terminating IP terminal, said return media data packets including the IP address of the terminating IP terminal as a source address, and the IP address of the second address translation function as a destination address;
translating, by the second address translation function, the source address in the return media data packets from the IP address of the terminating IP terminal to the IP address of the second address translation function;
translating, by the second address translation function, the destination address in the return media data packets from the IP address of the second address translation function to the IP address of the first address translation function;
sending, by the second address translation function, translated return media data packets to the first address translation function, said translated return media data packets including the IP address of the second address translation function as the source address;
translating, by the first address translation function, the source address in the translated return media data packets from the IP address of the second address translation function to the IP address of the first address translation function;
translating, by the first address translation function, the destination address in the translated return media data packets from the IP address of the first address translation function to the IP address of the originating IP terminal; and
sending, by the first address translation function, twice translated return media data packets to the originating IP terminal, said twice translated media data packets including the IP address of the first address translation function as the source address.
